(19) United States
(12) Patent Application Publication
(10) Pub. No.: US 2008/0142319 A1
(43) Pub. Date: Jun. 19, 2008

(54) BRAKE ROTOR HAVING CORRUGATED FIN STRUCTURE

(76) Inventor: Gary Manter, Hamilton, MA (US)

Correspondence Address: MICHAEL BEST & FRIEDRICH LLP, 100 E WISCONSIN AVENUE, Suite 3300, MILWAUKEE, WI, 53202, US

(21) Appl. No.: 11/955,540

(22) Filed: Dec. 13, 2007

Related U.S. Application Data
(60) Provisional application No. 60/869,965, filed on Dec. 14, 2006.

(51) Int. Cl. F16D 65/12; B23K 31/02; B23P 15/00

(52) U.S. Cl. 188/218 XL; 228/182

(57) ABSTRACT

A brake rotor having first and second brake plates and a corrugated fin structure. The fin structure has a plurality of fins. A first portion of each fin is metallurgically bonded to the first brake plate and a second portion of each fin is metallurgically bonded to the second brake plate. The use of a corrugated fin structure that is separately manufactured from the brake plates permits design choices with respect to fin type, fins per inch, material type and thickness, cross sectional shape of fin, and special fin characteristics that better permit the brake rotor to match its intended environment and expected performance.

This application claims priority to U.S. Provisional Patent Application No. 60/869,965 filed Dec. 14, 2006.

### FIELD OF THE INVENTION

The present invention relates to a brake rotor having a corrugated fin structure between two brake plates.

### BACKGROUND

Automobiles are manufactured with a multitude of characteristics such as mission, performance, weight, and driving environment, all of which should be taken into account when selecting the brake rotor design for one specific model. Regrettably, brake rotor design is often heavily influenced by manufacturing production costs, leading to compromised generic designs which are shared between many automobile models.

As brakes are applied in an automobile, kinetic energy is converted into thermal energy which must be dissipated by the brake rotor. The energy absorbed by the rotors can be calculated as follows, where E is the energy absorbed, M is the mass and V is the velocity of the vehicle: E=½MV². The rotor must absorb and transmit the thermal load at a rate so as to limit brake system component temperatures.

Brake rotor design commonly incorporates a dual plate arrangement with integral cooling vanes. In general, brake rotors outfitting today's domestic and performance automobile market are cast. There are inherent casting process limits which influence the quantity and detail of the cooling vanes built into these rotors.

The material most commonly used for conventional brake rotors is cast gray iron due to its superior heat transfer and damping (vibration absorption) characteristics. This material is, however, not corrosion resistant, and depending on environmental conditions, can rapidly degrade leading to surface scale, material loss, and diminished heat transfer.

Excessive brake rotor temperatures can lead to brake fade, pad adherence to rotor, overheating brake fluid, and component damage. Ideally, a brake rotor will effectively transfer heat when new and also following years of service. Also, with brake energy proportional to velocity squared, higher performance vehicles require brake rotors capable of transmitting more heat than conventional rotors.

### SUMMARY

In one embodiment, the invention provides a brake rotor comprising: first and second brake plates; and a corrugated fin structure manufactured separate from the brake plates and having a plurality of fins. A first portion of each fin is metallurgically bonded to the first brake plate and a second portion of each fin is metallurgically bonded to the second brake plate. In some embodiments, the fins are metallurgically bonded to the first and second brake plates by brazing. In some embodiments, braze filets bond the fins to the first and second brake plates. In some embodiments, the corrugated fin structure is constructed of a single length of fin material having first and second opposite ends, and the fins are provided in the fin material. In other embodiments, at least one fin at the first end of the fin material is nested into at least one fin at the second end of the fin material to cause the folded fin structure to take a general ring shape. In other embodiments, the corrugated fin structure includes about 15-40 fins per inch.

The invention also provides a method of manufacturing a brake rotor, the method comprising the steps of: (a) providing a first brake plate; (b) providing a second brake plate; (c) providing a length of corrugated fin material having first and second ends and defining a plurality of fins; (d) splaying the length of fin material into a ring-shaped fin structure; (e) applying high temperature nickel braze alloy to the brake plates or to the fin structure; (f) creating a rotor assembly by positioning the fin structure between the first and second brake plates, such that the braze alloy is between a first portion of the fins and the first brake plate and between a second portion of the fins and the second brake plate; (g) applying a compressive load to the rotor assembly to hold the first and second brake plates against the fin structure; and (h) while maintaining the compressive load, brazing the rotor assembly to metallurgically bond the fin structure to the first and second brake plates, and thereby create a brake rotor.

In some embodiments, steps (a) and (b) include providing the first and second brake plates as ring-shaped brake plates, each having an inner diameter and an outer diameter; and the inner diameter of the first brake plate is smaller than the inner diameter of the second brake plate to define a drive plate portion having holes to facilitate mounting the brake rotor to a rotating element. In other embodiments, providing a length of corrugated fin material in step (c) includes providing a flat length of fin material and folding or forming the fins in the fin material. In other embodiments, step (c) includes providing fins at a fin density of at least four fins per inch.

In other embodiments, step (d) includes nesting at least one fin of the first end of the fin material into at least one fin of the second end of the fin material. In other embodiments, step (d) includes placing the first and second ends of the fin material in contact with each other. In other embodiments, step (d) includes joining the first and second ends of the fin material to each other to create a stand alone, symmetrical fin structure. In other embodiments, step (d) includes spot welding the ring-shaped fin structure directly to the first brake plate.

In other embodiments, step (e) includes applying the nickel braze alloy across a portion of the first brake plate and a portion of the second brake plate sufficient to cover a full width of the fins; and step (f) includes placing substantially the entire width of the fins in contact with the nickel braze alloy. In other embodiments, step (h) includes creating braze filets between the fin structure and the brake plates, the method further comprising inspecting the braze filets with at least one of X-ray and ultrasound inspection.

In other embodiments, steps (a) and (b) include providing each of the first and second brake plates with a heat transfer surface and an oppositely-facing friction surface; step (e) includes applying the braze alloy to the heat transfer surfaces of the first and second brake plates; step (f) includes positioning the fin structure between the heat transfer surfaces of the first and second brake plates; and step (h) includes brazing the fin structure to the heat transfer surfaces of the first and second brake plates; and the method further comprises, after step (h) machining the friction surfaces of the first and second brake plates to be substantially parallel to each other. In other embodiments, the method further comprises measuring an overall thickness of the brake rotor in at least four locations to determine whether the friction surfaces of the first and second brake plates are substantially parallel to each other.

In other embodiments, steps (a) and (b) include providing each of the first and second brake plates in the form of ring-shaped brake plates, each having an inner diameter and an outer diameter; the method further comprising, after step (h), machining the inner and outer diameters of the brake plates to desired specifications.

Other aspects of the invention will become apparent by consideration of the detailed description and accompanying drawings.

### BRIEF DESCRIPTION OF THE DRAWINGS

FIG. 1 is a perspective illustration of a brake rotor embodying the invention.

FIG. 2 is an exploded view of the brake rotor.

FIG. 3 is an enlarged side view of a portion of the brake rotor, including a straight channel square crest fin type.

FIG. 4 is a perspective view of a lanced fin type which may be used in embodiments of the present invention.

FIG. 5 is a perspective view of a louvered fin type which may be used in embodiments of the present invention.

FIG. 6 is a perspective view of a ruffled fin type which may be used in embodiments of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

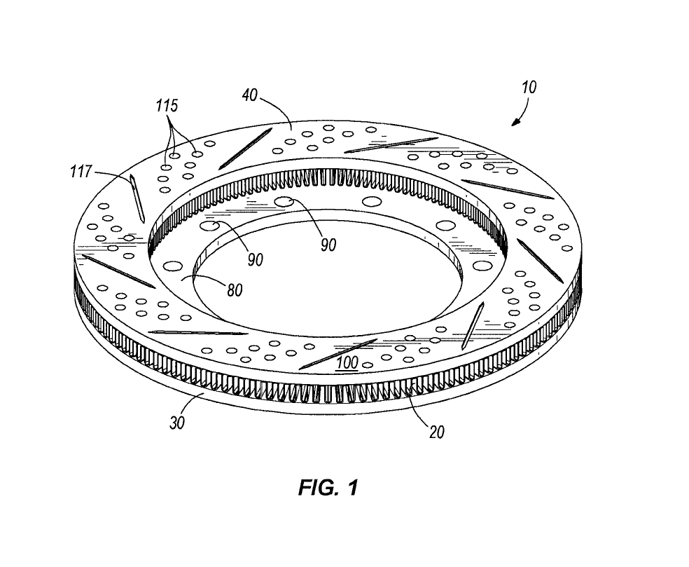

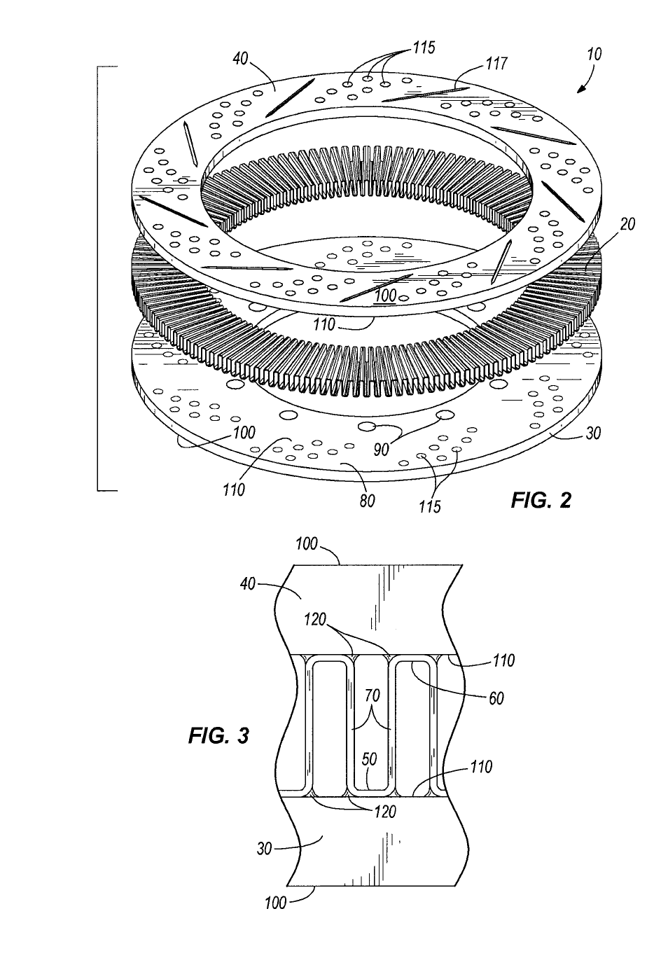

FIGS. 1-3 illustrate a brake rotor 10 that includes a corrugated fin structure 20 sandwiched between first and second brake plates or disks 30, 40.

The corrugated fin structure 20 includes a plurality of fins, each fin including a furrow 50, a ridge 60, and a leg 70 connecting or joining the furrow 50 and ridge 60. The fin structure 20 may be constructed from a single length of fin material (e.g., coil stock) that is separate from the brake plates 30, 40. The fin material is preferably characterized by a high thermal conductivity, and facilitates transfer of heat from the plates 30, 40 to the air or other fluid surrounding the brake rotor 10. The fin material may be formed into the corrugated shape (i.e., provided with the furrows 50, ridges 60, and legs 70) by any suitable technique, including but not limited to folding and forming.

The first plates 30 includes a drive plate portion 80 that includes holes 90 for mounting the brake rotor 10 to a rotating element (e.g., a wheel). The plates 30, 40 each have opposite sides providing a friction surface 100 facing away from the finned structure 20, and a heat transfer surface 110 facing toward the heat transfer surface 110 of the other plate 40, 30. The finned structure 20 is sandwiched between the heat transfer surfaces 110. The friction surface 100 provides a smooth, flat surface against which brake pads or other friction-promoting apparatus may be pressed to slow rotation of the rotating element to which the brake rotor 10 is mounted. The kinetic energy of the rotating element and brake rotor 10 is converted into thermal energy through the friction arising between the brake pad or other friction-promoting apparatus and the plates 30, 40, and the thermal energy causes the temperature of the plates 30, 40 to rise. To maintain the brake pad against the friction surface 100 with a substantially constant force and pressure, outgassing holes 115 and slots 117 may in some embodiments be provided in the plates 30, 40 and in the friction surfaces 100 to vent gases that build up between the brake pad and the friction surface 100.

The heat transfer surface 110 of each plate 30, 40 is metallurgically bonded (e.g., by welding, brazing, or another suitable technique) to the fin structure 20 to promote efficient conduction of heat from the plates 30, 40 into the fin structure 20. For example, in the illustrated embodiment, a first portion of each fin (i.e., the furrow 50) is metallurgically bonded to the heat transfer surface 110 of the first plate 30 and a second portion of each fin (i.e., the ridge 60) is metallurgically bonded to the heat transfer surface 110 of the second plate 40. During assembly, the fin structure 20 is fixtured between the plates 30, 40 to create a rotor assembly, and the fixtured assembly is brazed into an integral monolithic structure in the form of the brake rotor 10. Braze filets 120 are formed between the plates 30, 40 and the fin structure 20.

The majority of performance brake rotors built today are cast, with the brake plates and cooling vanes being formed as a monolithic structure of a single, uniform material. The present invention provides a method for manufacturing a brake rotor 10 with the plates 30, 40 and fin structure 20 being independently manufactured and then metallurgically bonded in a separate manufacturing step. The separate fin structure 20 of the present invention replaces the integral cooling vanes of a conventional cast brake rotor. The fin structure 20 of the present invention provides a larger surface area for heat transfer when compared to the cooling vanes of a conventional cast rotor. More specifically, the present invention can achieve fin densities of at least 4 fins per inch (fpi) and as high as 15-40 fpi. Such fin densities provide potential heat transfer surface area more then 4-10 times the surface area provided by the cooling vanes of known, integrally-cast brake rotors. High fin density also promotes uniform heat transfer from the plates 30, 40 while improving plate dimensional stability when under load. More uniform heat transfer reduces the likelihood of local plate hot spots developing in the plates 30, 40 and reduces the likelihood of plate deformation under load.

Separately manufacturing the plates 30, 40 and fin structure 20 permits material selection for the plates 30, 40 and fin structure 20 that better matches design and performance requirements. The fin structure 20 may include material characteristics such as high strength, high ductility, good heat transfer, and high corrosion resistance. Some suitable materials for the fin structure 20 include steel, nickel plated steel, stainless steel, Inconel nickel-based superalloys, and titanium. The brake plates 30, 40 may be constructed of materials having high strength, good heat transfer, dimensional stability at high temperature, and cast gray iron is one suitable material.

The use of a corrugated fin structure 30, 40 permits design choices with respect to fin type, fins per inch, material type and thickness, cross sectional shape of fin, and special fin characteristics. All of these component variations are managed by tooling and equipment setup. For example, fin material thickness and fin density are two variables that may be balanced for a desired rotor characteristic. As a general matter, as thicker fin material is used, lower fin densities are achievable, and as thinner fin material is used, higher fin densities can be achieved.

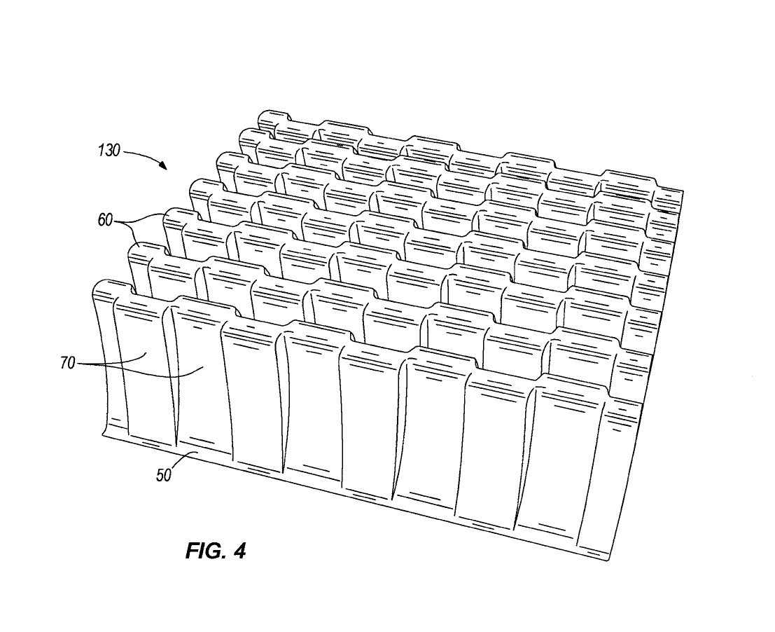

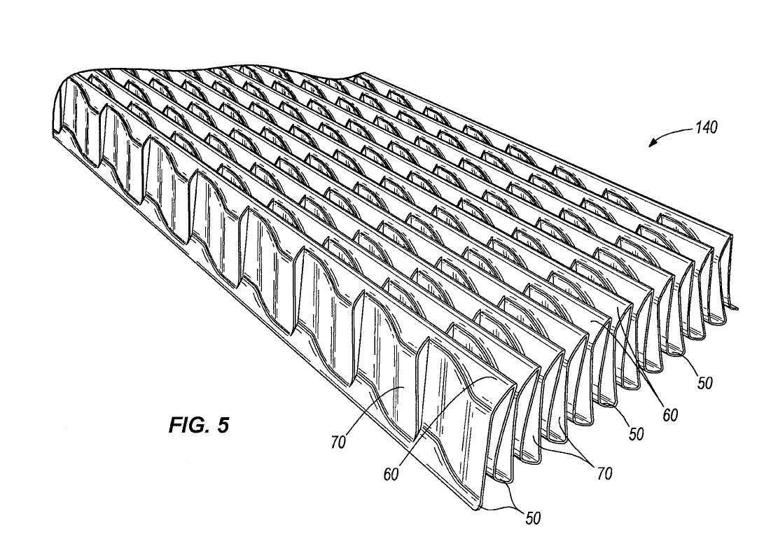

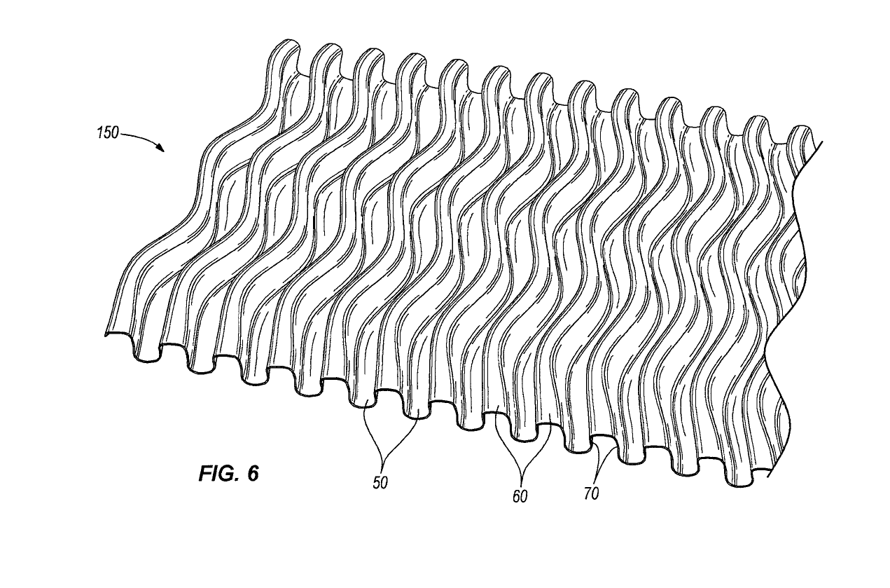

One example of a fin type that may be used in a rotor according to the present invention is the straight-channel square crest fin profile illustrated in FIG. 3. Other examples of fin types, all of which are currently manufactured by and available for purchase from Robinson Fin Company of Kenton, Ohio, include lanced 130, louvered 140, and ruffled 150 fin types, which are illustrated in FIGS. 4, 5, and 6, respectively. Each of the fin types includes alternating furrows 50 and ridges 60 connected by legs 70. Overall rotor heat transfer, strength, dimensional stability, and durability may be influenced by the fin type. Thus, brake rotors 10 may be designed to match customer requirements through variations in a single component (i.e., the fin type of the fin structure 20) rather than a completely new mold as would be required in a fully-cast brake rotor.

Non-wear surfaces of the brake plates 30, 40 (e.g., the heat transfer surface 110 and portions of the friction surface 100 that are not contacted by a brake pad) may be covered or coated with a high temperature chrome/nickel braze alloy coating such as Wall Colmonoy NB31 to improve corrosion resistance. The coating may be applied prior to fixturing and brazing the plates 30, 40 and fin structure 20.

Embodiments encompassing the principles of the invention are further explained by the following examples, which should not be construed by way of limiting the scope of the invention.

### EXAMPLES

### Example 1

### Build Methodology for 100% Stainless Steel Rotor Assembly

In one example method, the brake plates 30, 40 are cast and blanchard ground or waterjet cut directly from plate. These components prior to assembly will have parallel ground or machined surfaces and be stress relieved. Finished thickness prior to assembly would be approximately 0.275-0.325 inch thick. The fin structure 20 may be a round crest, lazy ruffle, 2.15 inch flow length, 20 fpi, 0.4 inch fin height, 0.016 inch thick stainless steel foil. In other embodiments, the fin material may have a thickness of between about 0.010 and 0.063 inches or any other thickness that is suitable for the application and permits the fin material to be folded, formed, or otherwise shaped in to a corrugated shape. This fin material as it is produced comes off machine as straight length, and is cut to length by the vendor as specified by customer.

The fin structure 20 is splayed around a cylindrical tool until the ends are in contact and joined by nesting and spot welding of the first furrows 50 and ridges 60. This step when undertaken with correct tooling results in a stand alone circular, symmetrical fin structure 20. Alternatively, the straight length of fin material is splayed by special tooling integrated with one of the powder coated brake plates 30, 40. Once the fin structure 20 is splayed and ends meet, the fin structure 20 is spot welded directly to the heat transfer surface of one of the brake plates 30, 40, and the spot welds hold the fin structure 20 in place until the braze process is complete.

High temperature nickel braze alloy (e.g., Wall Colmonoy NB31) is applied to the heat transfer surfaces 110 of the two brake plates 30, 40. The braze coating preferably covers the full width of the fin structure 20 once placed into position. A more precise application of braze alloy could be applied to just the portions of the plates 30, 40 contacted by the furrows and ridges 50, 60. In other embodiments, the braze coating could be applied to the furrows and ridges of the fin structure 20, rather than to the plates 30, 40. In other embodiments, the braze coating could be applied to both or a combination of portions of the fin structure 20 and the plates 30, 40. After the braze coating is applied to the brake plates 30, 40 and/or to the fin structure 20, the brake rotor assembly 10 is secured and registered in a fixture. The fixture applies uniform axial load to the brake rotor assembly 10 as the assembly is run through the brazing operation.

Following the braze process, the rotor 10 may be inspected. The inspection may include a visual inspection to ensure the braze filets 120 are complete as viewed from inner diameter (“ID”) and outer diameter (“OD”) of the rotor 10. The inspection may also include measuring the cross section of the rotor 10 in four locations to confirm that the brake plates 30, 40 (and more specifically, the friction surfaces 100) have been maintained parallel to each other. The inspection may also include, depending on performance requirements, X-ray or ultrasound inspection to verify 100% braze filet formation. Once the brazing process has been proven to be effective and consistent, one or more of the above-described inspection processes can be used as a periodic or random quality control measure on only a few of the braze rotors coming off a manufacturing line, rather than being applied to every rotor.

Following inspection, finish machine operations may be performed. Such finish machine operations may include: (a) blanchard or machine the friction surfaces 100 to flat/parallel condition; (b) finish machine the holes 90 in the drive plate portion 80; and if necessary (c) touch up OD/ID of the brake plates 30, 40. Depending on performance requirements the brake rotor 10 may also be balance to meet end use specifications.

### Example 2

### Build Methodology for Corrosion Resistant Steel or Iron Rotor

A rotor 10 may alternatively be constructed from steel or iron brake plates 30, 40 and a steel fin structure 20. Such rotor 10 would be constructed substantially according to the steps set forth in Example 1 above, and would achieve a finished product with excellent corrosion resistance capability. One modification to the method described in Example 1 for this rotor construction would be to coat all surfaces (except the portion of the friction surfaces 100 upon which the brake pad presses) with the braze alloy.

Thus, the invention provides, among other things, a brake rotor 10 including a corrugated fin between a pair of brake plates 30, 40, and a method for manufacturing such a brake rotor 10. Various features and advantages of the invention are set forth in the following claims.

What is claimed is:

1. A brake rotor comprising:
first and second brake plates; and
a corrugated fin structure manufactured separate from the brake plates and having a plurality of fins;
wherein a first portion of each fin is metallurgically bonded to the first brake plate and a second portion of each fin is metallurgically bonded to the second brake plate.

2. The brake rotor of claim 1, wherein the fins are metallurgically bonded to the first and second brake plates by brazing.

3. The brake rotor of claim 2, further comprising braze filets bonding the fins to the first and second brake plates.

4. The brake rotor of claim 1, wherein the corrugated fin structure is constructed of a single length of fin material having first and second opposite ends; wherein the fins are provided in the fin material.

5. The brake rotor of claim 4, wherein a least one fin at the first end of the fin material is nested into at least one fin at the second end of the fin material to cause the folded fin structure to take a general ring shape.

6. The brake rotor of claim 1, wherein the corrugated fin structure includes about 15-40 fins per inch.

7. A method of manufacturing a brake rotor, the method comprising the steps of:
(a) providing a first brake plate;
(b) providing a second brake plate;
(c) providing a length of corrugated fin material having first and second ends and defining a plurality of fins;
(d) splaying the length of fin material into a ring-shaped fin structure;
(e) applying high temperature nickel braze alloy to the brake plates or to the fin structure;
(f) creating a rotor assembly by positioning the fin structure between the first and second brake plates, such that the braze alloy is between a first portion of the fins and the first brake plate and between a second portion of the fins and the second brake plate;
(g) applying a compressive load to the rotor assembly to hold the first and second brake plates against the fin structure; and
(h) while maintaining the compressive load, brazing the rotor assembly to metallurgically bond the fin structure to the first and second brake plates, and thereby create a brake rotor.

8. The method of claim 7, wherein steps (a) and (b) include providing the first and second brake plates as ring-shaped brake plates, each having an inner diameter and an outer diameter; wherein the inner diameter of the first brake plate is smaller than the inner diameter of the second brake plate to define a drive plate portion having holes to facilitate mounting the brake rotor to a rotating element.

9. The method of claim 7, wherein providing a length of corrugated fin material in step (c) includes providing a flat length of fin material and folding or forming the fins in the fin material.

10. The method of claim 7, wherein step (c) includes providing fins at a fin density of at least four fins per inch.

11. The method of claim 7, wherein step (d) includes nesting at least one fin of the first end of the fin material into at least one fin of the second end of the fin material.

12. The method of claim 7, wherein step (d) includes placing the first and second ends of the fin material in contact with each other.

13. The method of claim 7, wherein step (d) includes joining the first and second ends of the fin material to each other to create a stand alone, symmetrical fin structure.

14. The method of claim 7, wherein step (d) includes spot welding the ring-shaped fin structure directly to the first brake plate.

15. The method of claim 7, wherein step (e) includes applying the nickel braze alloy across a portion of the first brake plate and a portion of the second brake plate sufficient to cover a full width of the fins; and wherein step (f) includes placing substantially the entire width of the fins in contact with the nickel braze alloy.

16. The method of claim 7, wherein step (h) includes creating braze filets between the fin structure and the brake plates, the method further comprising inspecting the braze filets with at least one of X-ray and ultrasound inspection.

17. The method of claim 7, wherein steps (a) and (b) include providing each of the first and second brake plates with a heat transfer surface and an oppositely-facing friction surface; wherein step (e) includes applying the braze alloy to the heat transfer surfaces of the first and second brake plates; wherein step (f) includes positioning the fin structure between the heat transfer surfaces of the first and second brake plates; and wherein step (h) includes brazing the fin structure to the heat transfer surfaces of the first and second brake plates; the method further comprising, after step (h) machining the friction surfaces of the first and second brake plates to be substantially parallel to each other.

18. The method of claim 17, further comprising measuring an overall thickness of the brake rotor in at least four locations to determine whether the friction surfaces of the first and second brake plates are substantially parallel to each other.

19. The method of claim 7, wherein steps (a) and (b) include providing each of the first and second brake plates in the form of ring-shaped brake plates, each having an inner diameter and an outer diameter; the method further comprising, after step (h), machining the inner and outer diameters of the brake plates to desired specifications.
